(19) United States
(12) Patent Application Publication
(10) Pub. No.: US 2019/0299937 A1
(43) Pub. Date: Oct. 3, 2019

(54) CONNECTION DEVICE FOR LINKING A WIPER BLADE TO A DRIVE ARM FOR A VEHICLE

(71) Applicant: Valeo Systèmes d'Essuyage, Le Mesnil Saint Denis (FR)

(72) Inventors: Vincent Gaucher, Issoire (FR); Stéphane Houssat, Issoire (FR); Olivier Jomard, Issoire (FR); Guillaume Mouleyre, Issoire (FR)

(73) Assignee: Valeo Systèmes d'Essuyage, Le Mesnil Saint Denis (FR)

(21) Appl. No.: 16/469,339

(22) PCT Filed: Nov. 27, 2017
(86) PCT No.: PCT/EP2017/080547

§ 371 Date: Jun. 13, 2019

(30) Foreign Application Priority Data
Dec. 13, 2016 (FR) 1662351

(51) Int. Cl. B60S 1/40

(52) U.S. Cl. CPC B60S 1/4048; B60S 2001/4093; B60S 2001/4058; B60S 2001/4051

(57) ABSTRACT

The subject of the invention is a connection device (10) intended to link a wiper blade to a drive arm of a wiper system for a vehicle, comprising: —an adapter (5) formed at least by an upper wall (50) from which emerge at least two lateral flanks (51), including a first lateral flank and a second lateral flank, so as to define an internal volume in which a connector (3) rigidly connected to the wiper blade is intended to extend, the first lateral flank and the second lateral flank each comprising one aperture aligned with the other; —an attachment member (7) comprising ends (71, 72), the attachment member (7) passing through at least the two apertures of the adapter (5), characterized in that at least one of the ends (71, 72), referred to as the first end (71), of the attachment member (7) extends beyond the first lateral flank (51) of the adapter (5) and in that at least one portion of this first end (71, 72) bears against the first lateral flank (51) of the adapter (5).

The invention relates to the field of wiping and/or cleaning glazed surfaces of a vehicle, in particular a motor vehicle, and more particularly concerns a connection device between a wiper blade and a drive arm thereof.

Wiper blades for motor vehicles are designed to wipe away liquids and dirt that can interfere with the view that the driver has of their environment. These wiper blades generally comprise at least one drive arm that effects an angular to-and-fro movement over a glazed surface of the vehicle and at least one wiper blade equipped with a wiper rubber made from a flexible plastic material. By rubbing against this glazed surface, the rubber wipes away the water and some of the dirt to evacuate them out of the field of view of the driver.

Whatever the configuration of the wiper blade: articulated clips that retain the wiper rubber in a number of distinct zones, or a metal spine that retains the wiper rubber over all its length, the latter is attached to the drive arm of the wiper system by a connection assembly that generally comprises at least a connector and an adapter. The connector is fastened to the wiper blade and the adapter is a part configured, on the one hand, to cooperate with the connector and, on the other hand, to be interengaged with a terminal part of the drive arm. The connector and the adapter then cooperate to fix the wiper blade to the drive arm and enable an articulated connection between them.

In the retrofit parts and accessories market, it is known to propose a generic wiper blade that is sold equipped with its own connector that can be adapted to fit several types of drive arm. It is then necessary to design an adapter usable with the greatest possible number of types of arm terminal parts and with the greatest possible number of wiper blade connectors, because it is the adapter that forms the interface between these two elements.

An object of the invention is to propose a solution enabling the connection of a wiper blade to a particular type of drive arm terminal part for a wiper system of a motor vehicle, which terminal part has, perpendicular to the longitudinal direction in which it extends, an inverted U-shaped section the vertical branches of which are constituted by two lateral walls of that terminal part and the transverse branch of which is formed by an upper wall of said terminal part. The upper wall and lateral walls of this terminal part therefore delimit between them a volume to receive the adapter according to the invention.

The particular terminal part to which the invention more precisely applies also includes two openings each arranged longitudinally on one of the lateral walls of the terminal part starting from a free end edge of that lateral wall.

An object of the invention is to propose an adapter enabling efficient use of these openings to connect the wiper blade and the drive arm.

To achieve its object the invention proposes a connection device intended to connect a wiper blade to a drive arm of a wiper system for vehicles, comprising:
an adapter formed at least by an upper wall from which extend at least two lateral flanks, including a first lateral flank and a second lateral flank, so as to delimit an internal volume in which a connector fastened to the wiper blade is intended to lie, the first lateral flank and the second lateral flank each comprising an orifice each aligned with the other,
a fixing member comprising ends, the fixing member passing through at least the two orifices of the adapter.

characterized in that at least one of the ends of the fixing member, termed the first end, extends beyond the first lateral flank of the adapter and in that at least a portion of that first end bears against the first lateral flank of the adapter.

The fixing member passing through the orifices therefore enables immobilization of the adapter and the drive arm in a vertical direction and the presence of the portion bearing against the flank of the adapter enables immobilization in a transverse direction.

According to various features of the invention, considered separately or in combination:
The portion of the first end may bear against an external face of the first lateral flank.
At least one lateral edge of the portion of the first end may be configured to come to bear against a terminal part of a drive arm. The fixing member may therefore participate in blocking movement between the adapter and the drive arm. The bearing surface formed by the peripheral edge of the portion may enable mechanical immobilization of the adapter on the drive arm, in particular along a vertical axis, and therefore enable connection of a wiper blade to the drive arm. To be more precise, the peripheral edge of the portion may be configured to come to bear against an edge delimiting an opening present on a lateral face of the terminal part of the drive arm.
The fixing member may comprise a second end opposite the first end and between which ends a cylinder extends.
The portion of the first end may comprise a first base delimiting a first shoulder relative to the cylinder.
The cylinder may be configured to form a pivot for the connector of the wiper blade. This kind of cylindrical fixing member enables a wiper blade connector and a drive arm to be fastened together via the adapter whilst allowing movements in rotation of the connector relative to the adapter and to the drive arm, in particular because of this pivot.
The second end of the fixing member may extend beyond the second lateral flank of the adapter.
The second end may comprise a portion, termed the second portion, bearing against the second lateral flank of the adapter. To be more specific, the second portion may bear against the external face of the second lateral flank.
The second portion may comprise at least one second base delimiting at least one second shoulder relative to the cylinder. This second base may have a smaller section than the base situated at the first end, so that it can be inserted in the orifices of the flanks of the adapter.
The second base may be configured to come to bear against a terminal part of a drive arm.
The second base may comprise at least one flat configured to come to bear against the terminal part of the drive arm. To be more precise, the second base may be configured to come to bear against an edge surface delimiting an opening in a lateral face of the terminal part of the drive arm.
The second end of the fixing member may be elastically deformable. This kind of elastically deformable end enables this second end of the fixing member to be inserted in an orifice and, once it has passed through the orifice, to expand to its initial shape. This expansion then enables transverse immobilization of the fixing member. The fixing member is therefore retained on the one hand by the shoulder of the first end and on the other hand by the elastically deformable second end.
The elastically deformable second end may comprise a slot. This kind of slot allows movement toward each other of the two branches of the slot in a direction perpendicular to a longitudinal plane in which the latter extends, and then allows return of the branches to their initial position when the surrounding space is sufficiently large, that is to say when the lateral flank of the adapter has been passed.
The slot may occupy at least one third of the fixing member as it extends from the second end of the fixing member. The second end may then be divided into two branches each having a base.
The fixing member may be a part distinct from the adapter. By this is meant that the fixing member may be an attached part. It is also distinct from the connector and the drive arm. By distinct is meant that the fixing member may be separated from the adapter without damaging these two components and rendering one or the other of these components unusable.
The adapter may comprise a device for blocking movement in translation of the adapter on the drive arm.
The blocking device may be a finger disposed on the upper wall of the adapter, the finger being configured to be inserted in a window formed in a terminal part of a drive arm. To be more precise, the finger enables blocking movement of the adapter and the terminal part of the drive arm in a longitudinal direction and in a transverse direction.
The finger may be situated at a longitudinal end of the adapter.
The adapter may comprise a change of section arranged at the intersection of a head and a body of the adapter, the head and the body extending in line with each other in a longitudinal direction of the adapter.
The head of the adapter may have external dimensions, such as the height and the width, greater than the external dimensions of the body of the adapter.
The orifices of the adapter may be situated in the body of the adapter.
A wall forming the change of section may extend in a plane that is oblique relative to a plane in which an upper wall of the body extends.
The oblique wall of the change of section may be situated at the level of the upper wall of the body of the adapter. To be more precise, this oblique wall may extend vertically in line with the upper wall.

The invention also consists in an assembly for connecting a wiper blade to a drive arm of a vehicle wiper system, comprising:
a connection device as defined above, and
a connector intended to be fastened to a wiper arm, the connector being disposed in the internal volume of the adapter,

characterized in that the connector comprises a hole aligned with the orifices of the adapter and in that the fixing member extends in the hole of the connector and the orifices of the adapter. The fixing member passing through the orifices therefore enables immobilization of the adapter and of the connector in a vertical direction and the presence of the portion bearing against the lateral flank of the adapter enables immobilization in a transverse direction. The connection device therefore enables connection of the connector to the adapter via the fixing member. A single operation then makes the mechanical connection between the connector, the adapter and the terminal part of the wiper blade.

The invention also consists in a vehicle wiper system comprising:
a connection assembly as defined above,
a drive arm comprising a terminal part cooperating with the connection assembly, the terminal part having a U-shaped section defining an upper face from which extend lateral faces, at least one of the lateral faces comprising an opening.

According to various features of the invention considered separately or in combination:
A peripheral edge of the portion of the fixing member may be in contact with an edge surface defining the opening situated in at least one of the lateral faces.
The opening of at least one of the lateral faces may open onto an end edge of said lateral face.
The portion of the fixing member may have a shape complementary to the opening. To this end, the portion of the fixing member may have an oblong shape in order to cooperate with an oblong opening.
The upper face of the drive arm may comprise a window in which the finger of the adapter extends.

The invention also consists in a method of assembling a connection assembly onto a drive arm of a vehicle wiper system as defined above, characterized in that it comprises in succession:
a step of positioning the adapter in the terminal part of the drive arm, and
a step of inserting the fixing member into an opening formed by the alignment of the orifices of the adapter with the opening or openings of the terminal part of the drive arm.

According to various implementations of the method considered separately or in combination:
The positioning step may be followed by a step of rotating the adapter relative to the drive arm.
The positioning step may comprise abutting an oblique wall of a change of section of the adapter on a free end edge of the upper face of the terminal part of the drive arm.
At the end of the rotation step the latter may comprise insertion of a finger of the adapter into a window arranged on the upper face of the terminal part of the drive arm.
The method may comprise a step of longitudinal movement in translation of the adapter on the drive arm after the rotation step.
The method may comprise a step of placing a connector in the internal volume of the adapter.
The opening formed by the alignment of the orifices of the adapter with the opening or openings of the terminal part of the drive arm may also comprise a hole of the connector.
The step of inserting the fixing member may comprise abutting the insertion member on one of the lateral flanks of the adapter, advantageously on an external face of the lateral flank.

Other features and advantages of the present invention will become more clearly apparent with the aid of the following description and the drawings, in which:

FIG. 1 is a perspective view of a drive arm assembled to a wiper blade to form a wiper system for a motor vehicle,

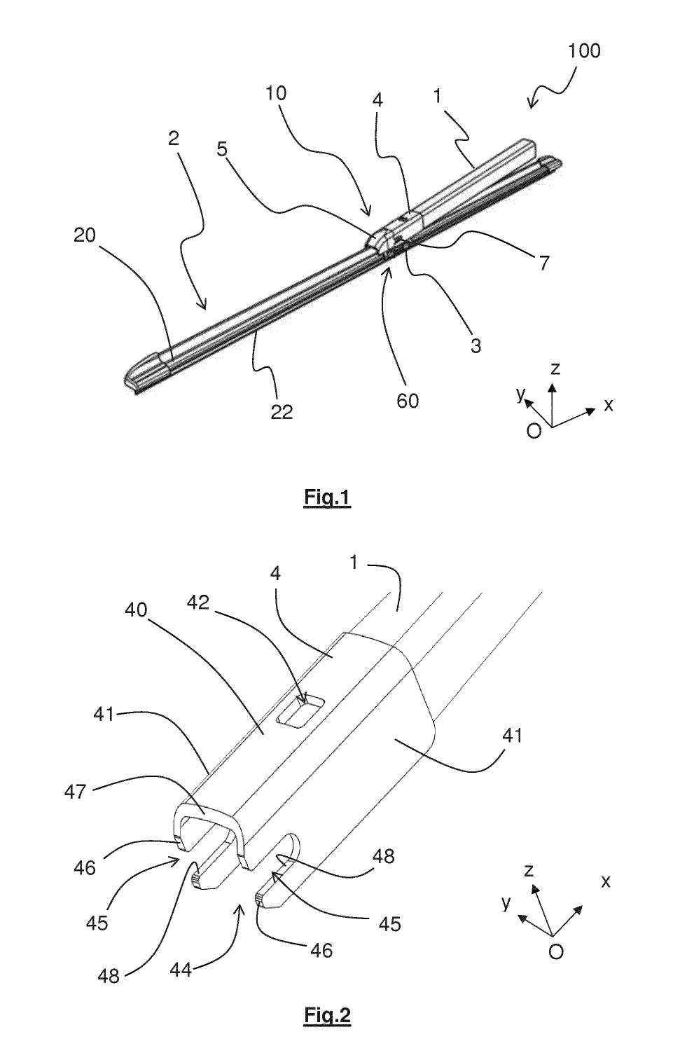

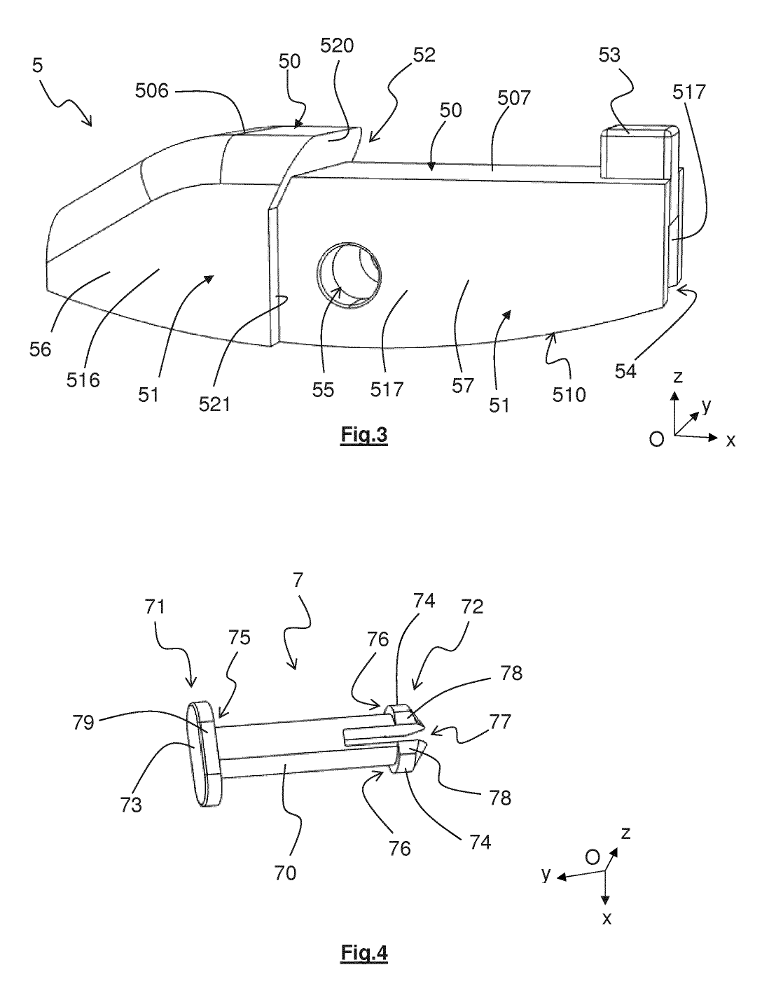

FIG. 2 is a perspective view of a terminal part of the drive arm with which a connection device according to the invention is intended to cooperate,

FIG. 3 is a perspective view of an adapter according to the invention,

FIG. 4 is a perspective view of a fixing member according to the invention,

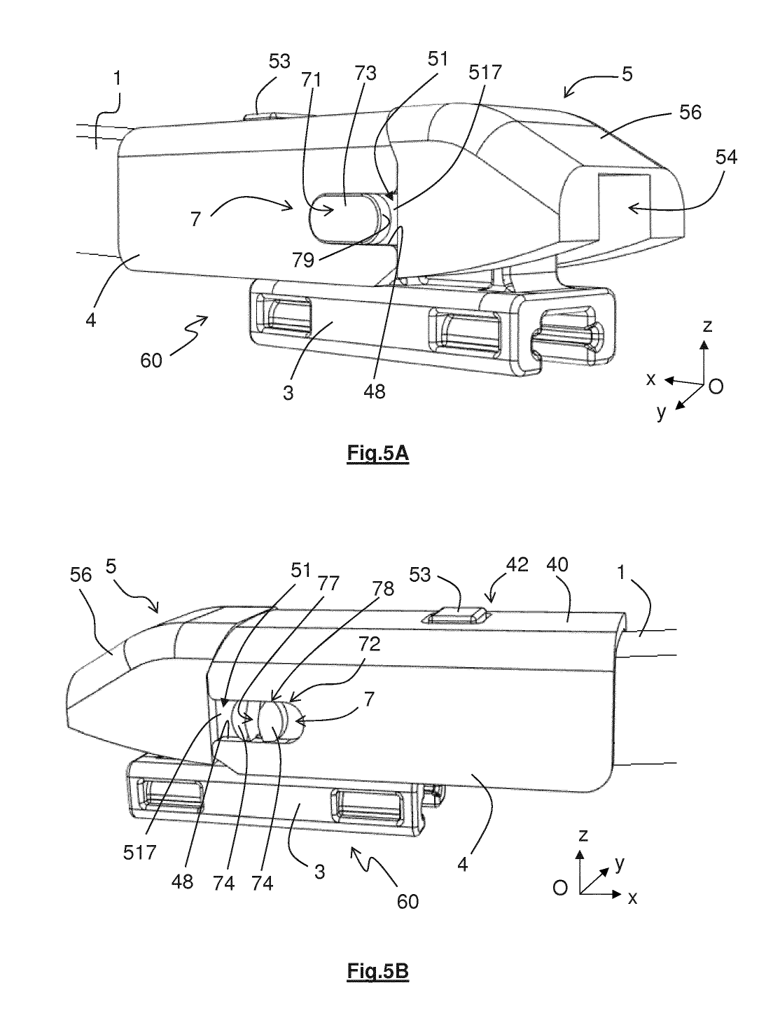

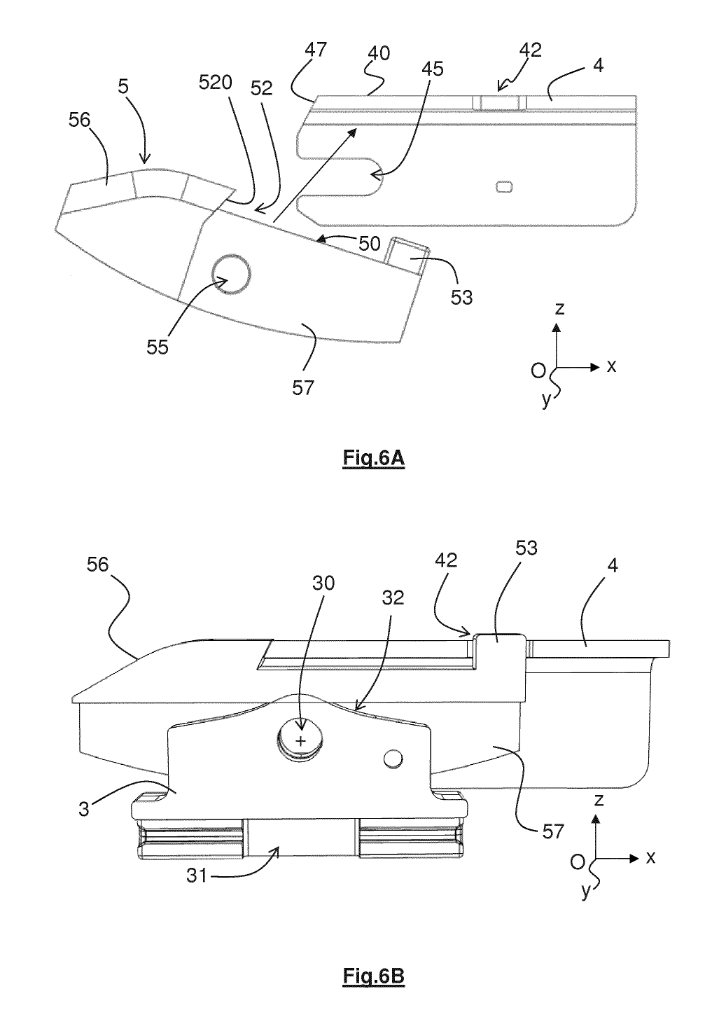

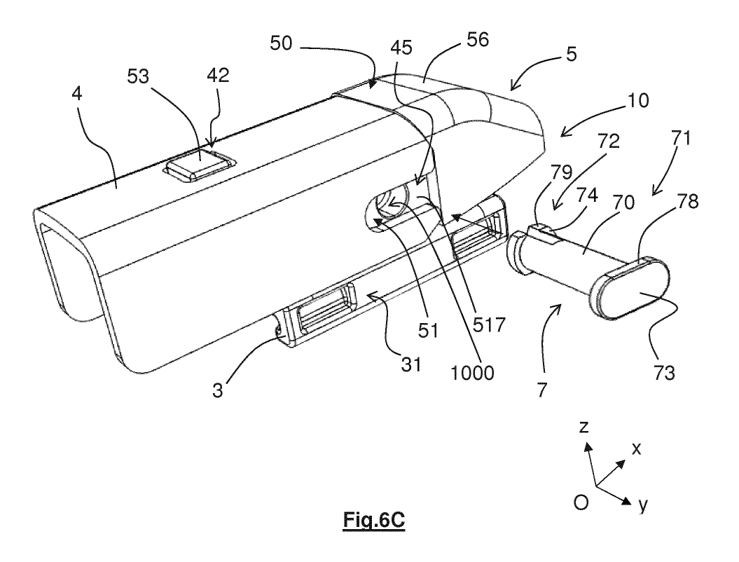

FIGS. 5A and 5B are perspective views of a connection assembly according to the invention mounted on the drive arm, respectively seen from a first side and then seen from a second side,

FIG. 6A is a sectional view showing steps of an assembly method according to the invention, in which an adapter is positioned relative to the terminal part of the drive arm,

FIG. 6B is a sectional view showing an additional step of the assembly method according to the invention, and

FIG. 6C is a perspective view showing a final step of the assembly method according to the invention showing the insertion of the fixing member into an opening formed by the alignment of the orifices of the adapter, the hole of the connector and an opening of the drive arm.

Note first that although the figures disclose the invention in detail for the purposes of its execution, they may of course serve to define it better if necessary. It is also to be noted that, in all the figures, similar elements are indicated by the same reference. For reasons of the legibility of the figures, the wiper blade has not always been shown.

In the figures, the terms longitudinal, transverse, vertical, lateral, front, rear, left, right, upper, lower refer to the orientation of a wiper blade 2 shown in FIG. 1. A longitudinal direction corresponds to a longitudinal axis Ox along which the wiper blade 2 extends and/or along which extends a connection device 10 of the present invention. A transverse direction corresponds to that of a transverse axis Oy that is perpendicular to the longitudinal axis Ox. The terms left and right are to be understood relative to a position along the transverse axis Oy, on either side of the longitudinal axis Ox. A vertical direction, parallel to that of a vertical axis Oz, is perpendicular to the aforementioned longitudinal and transverse directions. The terms upper and lower refer to orientations parallel to the vertical axis Oz, the term lower containing the plane of the windshield. For the longitudinal directions, the terms exterior and interior are to be understood relative to a pivot point of the wiper blade 2 on a drive arm 1 of the wiper blade 2, the term interior corresponding to the part in which the drive arm 1 and a half-blade extend, the term exterior corresponding to the part in which the other half-blade extends.

The directions referred to above are illustrated in an orthonormal frame of reference Oxyz represented in the figures. In that frame of reference, the axis Ox represents the longitudinal direction, the axis Oy represents the transverse direction, and the axis Oz represents the vertical direction.

FIG. 1 shows a motor vehicle wiper system 100. That wiper system 100 comprises a drive arm 1 that effects an angular to-and-fro movement against a surface to be wiped and cooperating with a wiper blade 2. Here the wiper blade 2 comprises at least one spine 20 bearing a wiper rubber 22 made from a flexible material. In the angular to-and-fro movement of the drive arm 1, the wiper blade 2 and its wiper rubber 22 are driven in an angular movement against the glazed surface to carry out the required wiping/cleaning operation. The wiper blade 2 is attached to the drive arm 1 by a connection assembly 60 that comprises a connector 3 and a connection device 10. The connector 3 is fastened to the wiper blade 2 and the connection device 10 provides an interface between that connector 3 and a terminal part 4 of the drive arm 1. Connector 3 and connection device 10 cooperate with each other to connect the wiper blade 2 to the drive arm 1 whilst allowing an articulation between those two elements.

To be more precise, the subject matter of the invention is the connection device 10 comprising an adapter 5 and a fixing member 7. That adapter 5 and that fixing member 7 cooperate with each other to connect the connector 3 of the wiper blade 2 to a particular type of terminal part 4 of the drive arm 1, in particular with the aim of supplying spare parts for wiper systems 100 in which the drive arm 1 includes this particular type of terminal part 4.

The terminal part 4, shown diagrammatically in FIG. 2, with which the adapter 5 according to the invention is intended to cooperate includes an upper face 40 from which extend substantially perpendicularly two lateral faces 41. It is to be noted that by the term “face” is to be understood an upper wall or lateral wall of the terminal part 4. The terminal part 4 therefore has at least one cross section the shape of which is substantially that of an inverted “U” the base of which is formed by the upper face 40 and the branches of which are formed by the lateral faces 41. Upper face 40 and lateral faces 41 of this terminal part 4 together delimit a receiving volume 44.

The at least one lateral face 41 includes an opening 45. An opening 45 is advantageously arranged in each of the lateral faces 41 of the terminal part 4. Here the terminal part 4 comprises two openings 45. The opening 45 may for example take the form of an oblong hole extending substantially lengthwise in the lateral face 41, in the direction of an elongated part of the drive arm 1. The opening 45 extends from a free end edge 46 of the corresponding lateral face 41 and opens onto the latter, as shown in FIG. 2. In other words, the free end edge 46 of the lateral face 41 is not rectilinear. It is to be noted at each opening 45 is delimited by an edge surface 48 of the lateral face 41.

The terminal part 4 also comprises a window 42 arranged on the upper face 40. That window 42 is situated equidistantly from the lateral faces 41 and is positioned closer to the drive arm 1 than a free end edge 47 of the upper face 40. The window 42 is for example rectangular or square.

FIG. 3 shows that the adapter 5 according to the invention is formed at least by an upper wall 50 from which extend at least two lateral flanks 51, including a first lateral flank and a second lateral flank, so as to delimit an internal volume 54 in which the connector 3 is intended to lie. The adapter 5 also comprises two orifices 55 each arranged in one of the lateral flanks 51, the orifices 55 being aligned on a common straight line segment. By aligned on a common straight line segment is meant that this straight line segment is parallel to the direction Oy and passes through the centers of the two orifices 55. The orifices 55 are preferably circular.

The orifices 55 are configured to be aligned with at least part of the openings 45 arranged on the terminal part 4. It is to be noted that the lateral flanks 51 have free lower edges 510 having a curved shape in order to enable movements of the connector 3 in rotation along these curved edges 510.

Also, the adapter 5 comprises a shoulder 52, also termed a change of section, enabling delimitation of a head 56 and a body 57 that extend longitudinally in line with each other along the axis (Ox) defined above. Referred to the directions and orientations defined above, the head 56 extends toward the exterior and the body 57 extends toward the interior. According to one embodiment of the invention, the adapter 5 is injection molded in one piece from a polymer material. It is to be noted that the orifices 55 are preferably arranged in the body 57 of the adapter 5.

The presence of the change of section 52 implies a difference of external dimensions between the head 56 and the body 57. The head 56 has a cross section having dimensions greater than the dimensions of a cross section of the body 57. These dimensions are for example an external perimeter or an area. According to one embodiment of the invention, the vertical and transverse dimensions of this change of section 52 are respectively substantially equal to the thickness of the upper face 40 of the terminal part 4 of the drive arm 1 and the thickness of the lateral faces 41 of that same terminal part 4 with which the adapter 5 according to the invention is intended to cooperate, so that the free end edge 47 of the upper face 40, as can be seen in FIG. 2, is able to come to bear against the change of section 52. These kinds of features make it possible to obtain a head 56 that is flush with the exterior faces of the terminal part 4 of the drive arm 1. It is then clear that only the body 57 of the adapter 5 is intended to be covered by the terminal part 4.

As can be seen in FIG. 3, the head 56 is formed of an upper wall 506, two substantially vertical lateral flanks 516 each extending substantially perpendicularly from one longitudinal side of the upper wall 506.

It is also possible to define the body 57 as comprising an upper wall 507, two substantially vertical lateral flanks 517 each of which extends substantially perpendicularly from a longitudinal side of the upper wall 507. To be more precise, each of the lateral flanks 517 has external faces against at least one of which a fixing member 7 is configured to come to bear. The lateral flanks 517 also comprise internal faces that delimit the internal volume 54. According to the embodiment shown in the figures, the longitudinal dimension of the body 57 is greater than its transverse dimension.

Head 56 and body 57 therefore each have, in a cross section plane parallel to the plane (Oyz) of the frame of reference defined above, an inverted U-shaped cross section the transverse base of which is constituted of the upper walls 506 and 507, respectively, and the vertical branches of which are formed by the lateral flanks, 516, 517, respectively.

Vertical walls 521 forming the change of section 52 extend substantially parallel to the vertical transverse plane (Oyz) of the orthonormal frame of reference defined above, whereas a transverse wall 520 forming the change of section 52 at the level of the upper wall 50 extends obliquely relative to the vertical transverse plane (Oyz). In other words the transverse wall 520 extends obliquely, that is to say neither perpendicularly nor parallel, relative to the upper wall 507 of the body 57 of the adapter 5.

Also, the upper wall 50 of the adapter 5 comprises a device configured to block movement in translation of the adapter 5 on the drive arm 1. This blocking device is intended to be inserted in the window 42 provided on the terminal part 4 of the drive arm 1 described above. To this end, the blocking device may be a finger 53 having a shape substantially complementary to the window 42 and able to feature an intentional clearance with the window 42. Here the finger 53 is carried by the body 57 of the adapter 5, in particular emerging from the upper wall 507 of the body 57. A finger 53 of this kind is disposed at a longitudinal end of the body 57 opposite the head 56 relative to the body 57.

According to the invention, the connection device 10 also comprises a fixing member 7, such as that in the embodiment shown in FIG. 4. The fixing member 7 is an attached part and is intended to pass through at least one and advantageously both orifices 55 of the adapter 5. The fixing member 7 then comprises ends, including a first end 71 and a second end 72, between which extends a cylinder 70. These ends 71, 72 represent the longitudinal ends of the fixing member 7.

The first end 71 comprises a first portion, which may take the form of a base 73 delimiting a first shoulder 75 relative to the cylinder 70. The base 73 has a peripheral edge 79 that surrounds the base 73, that is to say around the external perimeter of the base 73. This base 73 may have a shape substantially complementary to the opening 45 of the terminal part 4 of the drive arm 1, as can be seen in FIG. 2. In this instance, the base 73 has an oblong shape. The base 73 has dimensions preventing its insertion in the orifices 55 of the adapter 5. In other words the base 73 has a section larger than the section of the orifice 55 of the adapter 5 around which it is intended to bear.

The second end 72 of the fixing member 7 is preferably elastically deformable. This kind of elastically deformable end enables the fixing member 7 to be inserted in and to slide in the orifices 55 of the adapter 5 at this second end 72 and then, once the orifice 55 has been passed, to expand to its initial shape. This expansion then enables the fixing member 5 to be locked in position.

To this end the elastically deformable second end 72 may comprise a slot 77 extending lengthwise of the fixing member 7. This kind of slot 77 enables deformation in a direction perpendicular to a longitudinal plane of the slot 77 and then enables a return to its initial shape when the surrounding space allows it, that is to say when the lateral flank 517 of the body 57 has been passed. Of course, any other way of making the second end 72 elastically deformable is covered by the invention. The gap produced by the slot 77 determines the elasticity of the second end 72. Here the slot 77 occupies one third of the length of the fixing member 7. The slot 77 alternatively or additionally occupies one third of the width of the fixing member 7. The length is measured along the longitudinal axis of the fixing member 7 and the width is measured along a straight line segment perpendicular to the longitudinal plane of the slot 77.

The slot 77 extends from the second end 72 of the fixing member toward the first end 71. The slot 77 then divides the second end 72 into two branches. Note then that, in the embodiment, the second end 72 includes two portions 74, also termed bases, each delimiting shoulders 76. Those shoulders 76 preferably have the same dimensions as each other. Of course, the shoulders 76 of the second end 72 and the slot 77 have dimensions allowing insertion of the fixing member 7 into the orifices 55 of the adapter 5. It is to be noted that each of the bases 74 has peripheral edges and those peripheral edges may comprise flats 78 intended to come into contact with the edge surfaces 48 defining the openings 45 of the terminal part 4, as shown in FIG. 2.

The length of the fixing member 7 is such that at least one of the ends 71, 72 of the fixing member 7 is configured to extend beyond one of the lateral flanks 51 of the adapter, to be more precise one of the flanks 517 of the body 57 of the adapter 5, when the fixing member 7 is inserted in the orifices 55 of the adapter 5. In other words, the dimension of the fixing member 7 along the axis (Oy) defined above is advantageously greater than a width of the adapter 5 measured along that same axis (Oy). At least a portion of this end 71, 72 extending beyond the lateral flank 51, 517, bears at least in part in a plane (Oxz) along the external surface of the lateral flank 21 against the lateral flank 51, 517 of the adapter 5 or of the body 507 of the adapter 5. The portion is for example formed by the base 73 and/or by the bases 74.

In fact, as can be seen in FIGS. 5A and 5B showing the connection assembly 60 mounted on the drive arm 1, from one side and then the other, the two ends 71, 72 of the fixing member 7 extend on both sides beyond the lateral flanks 51, 517 of the adapter 5 and a face of the base 73 and the bases 74 of the fixing member 7 bear against an external face of the lateral flanks 51, 517 of the adapter 5. To be more precise, the faces defining the shoulders 75, 76 of the base 73 and the bases 74 bear against the external face of the lateral flanks 51, 517. The fixing member 7 is therefore retained on the axis (Oy) on the one hand by the first base 73 and on the other hand by the shoulders 76 of the elastically deformable end.

Also, when assembling the connection device 10 according to the invention with a terminal part 4 of the type described above and shown in FIG. 2, the fixing member 7 comes to bear against the edge surface 48 of the opening 45 arranged on the corresponding lateral face 41 of the terminal part 4. To be more precise, at least one peripheral edge 79 of the base 73 and/or the bases 74 forms a surface bearing against the edge surface 48 delimiting the openings 45 present in the terminal part 4 of the guide arm 1. The bearing surfaces formed then enable retention of the drive arm 1 in position relative to the adapter 5, in particular in a vertical direction (Oz). Of course, as a function of the dimensions and the exact configuration of this opening 45, and in particular as a function of the dimension of this opening 45 along the axis (Oz), the shape of the peripheral edges of the base 73 and/or the bases 74 of the fixing member 7 may be adapted to suit any other shape of the opening 45.

It will be noted that the base 73 extends at the minimum within the thickness of the lateral face 41. In a similar manner, the bases 74 extend at the minimum within the thickness of the lateral face 41.

Once the fixing member 7 is bearing against the edge surface 48 of the opening 45 all movement along the axis (Oz) of the adapter 5 relative to the terminal part 4 is prevented: the invention therefore enables blocking of movement of the adapter 5 relative to the drive arm 1. It will be noted that whatever the configuration and the exact dimensions of the opening 45, at least a portion of the end of the fixing member 7 is simultaneously in contact with the top edge 48 and/or the bottom edge of the opening 45.

Accordingly, the fixing member 7 passing through the openings 45 of the drive arm 1, the orifices 55 of the adapter 5 and advantageously a hole of the connector 3 enables connection of the wiper blade 22 to the drive arm 1, whilst allowing movements in rotation of the wiper blade 2 relative to the adapter 5 and to the drive arm 1. In fact, the fixing member 7 is also intended to enter a hole provided in the connector 3 of the wiper blade 2. Remember that here the connector 3 is positioned in the internal volume 54 of the adapter 5. The fixing member 7 then enables the connector 3 to remain fastened to the adapter 5 in all vertical, longitudinal and transverse directions. The cylinder 70 of the fixing member 7 then forms a pivot for the connector 3, then allowing movement in rotation about the fixing member 7.

FIGS. 6A to 6C show successive steps of a method of assembling the connection device 10 according to the invention with a terminal part 4 of the type described above and shown in FIG. 2 and where applicable with a connector 3 of a wiper blade.

FIG. 6A shows in section a first assembly step corresponding to a step of positioning the adapter 5 in the terminal part 4 of the drive arm 1. In fact, to cause the adapter 5 to enter the receiving volume 44 of the terminal part 4 the transverse wall 520 of the adapter 5 forming the change of section 52 at the level of the upper wall 50 is positioned so as to be abutted against the free end edge 47 of the upper face 40 of the terminal part 4. To this end, the adapter 5 is inserted from underneath the terminal part 4.

Once the transverse wall 520 has been abutted on the end edge 47 of the upper face 40, the assembly method comprises a step of rotation of the adapter 5 relative to the drive arm 1 toward the terminal part 4. To be more precise, this rotation step comprises bringing the upper wall 50 of the adapter 5 into contact with an internal face of the upper face 40 of the terminal part 4. In other words, the body 57 of the adapter 5 comes into contact with the internal face of the upper face 40. The finger 53 of the adapter 5 is then inserted in the window 42 arranged in the upper face 40 of the terminal part 4. The exterior dimensions in particular of the body 57 of the adapter 5 are advantageously defined to enable this guiding and this insertion. In other words, the exterior dimensions of the body 57 of the adapter 5 according to the invention are advantageously less than the interior dimensions of the receiving volume 44 defined above in the terminal part 4 to enable easy but snug, i.e. without excessive clearance, insertion.

After this rotation step the assembly method may comprise a step of longitudinal movement in translation of the adapter 5 along the terminal part 4 toward the drive arm. This step enables reduction of a longitudinal clearance between the transverse wall 520 and the end edge 47 of the upper face 40.

As shown in FIG. 6B, the connector 3 may be placed in the internal volume 54 of the adapter 5. To this end the connector 3, preferably fastened to the wiper blade 2, is placed in the internal volume 54 of the adapter 5 by movement in translation along the axis (Oz).

It may then be noted that the connector 3 comprises a first part 31 to be fastened to the wiper blade 2 and a second part 32 configured to cooperate with the connection device 10. That second part 32 comprises a hole 30 intended to have a fixing member 7 passed through it.

As shown in FIG. 6C, the method ends with a step of insertion of the fixing member 7 into an opening 1000 formed by aligning the orifices 55 of the adapter 5 with the openings 45 of the terminal part 4 of the drive arm 1 and advantageously with the hole 30 of the connector 3. To this end the fixing member 7 is inserted second part 72 first by a movement in the direction (Oy). During insertion, the second part 72 is then deformed elastically to pass through the various elements. Insertion ends when the insertion member 7, here its first end 71, abuts on the lateral flank 51, 517 of the adapter 5. The dimensions of the fixing member 7 and its configuration relative to the various elements through which it passes are defined so that, when it is inserted in the opening 1000, it blocks it completely.

Once inserted in the opening 1000 the base 73 occupies the opening 45 and its complementary shape prevents the fixing member 7 from turning about the longitudinal axis along which it extends.

It is to be noted that, once the connection device 10 according to the invention has been assembled with the terminal part 4 of the drive arm 1, the upper walls 40 and 506 of that terminal part 5 and of the head 56 of the adapter 5, respectively, as well as the lateral faces 41 of this terminal part 4 and the lateral flanks 516 of the head 56 of the adapter, advantageously form a continuous surface, thus contributing to the overall aesthetic, and also eliminating any zone where accumulation of debris, dirt or particles could be potentially harmful to correct operation of the assembly.

By simple members that are easy to use the invention therefore enables simple and efficient connection of a wiper blade 2 to a drive arm 1 having a terminal part 4 of the specific type described above. However, the invention should not be seen as limited to the members and configurations described and shown, and applies equally to all equivalent members or configurations and to any combination of such members.

In particular, according to different variant embodiments, the connection device 10 according to the invention and more particularly the fixing member 7 may include only one end portion bearing on one of the lateral flanks 51, 517 of the adapter 5.

1. A connection device configured to connect a wiper blade to a drive arm of a wiper system for vehicles, the connection device comprising:
an adapter formed at least by an upper wall from which extend at least two lateral flanks, including a first lateral flank and a second lateral flank, so as to delimit an internal volume in which a connector fastened to the wiper blade lies, the first lateral flank and the second lateral flank each comprising an orifice (55) each aligned with the other; and
a fixing member comprising ends, the fixing member passing through at least the two orifices of the adapter,
wherein at least one of the ends of the fixing member, termed the first end, extends beyond the first lateral flank of the adapter and wherein at least a portion of that first end bears against the first lateral flank of the adapter.

2. The connection device as claimed in claim 1, wherein the portion of the first end bears against an external face of the first lateral flank.

3. The connection device as claimed in claim 1, wherein at least one peripheral edge of the portion of the first end is configured to come to bear against a terminal part of a drive arm.

4. The connection device as claimed in claim 1, wherein the fixing member comprises a second end opposite the first end between which ends a cylinder extends.

5. The connection device as claimed in claim 4, wherein the portion of the first end comprises a first base delimiting a first shoulder relative to the cylinder.

6. The connection device as claimed in claim 4, wherein the cylinder is configured to form a pivot for the connector of the wiper blade.

7. The connection device as claimed in claim 4, wherein the second end of the fixing member extends beyond the second lateral flank of the adapter.

8. The connection device as claimed in claim 7, wherein the second end comprises a portion, termed the second portion, bearing against the second lateral flank of the adapter.

9. The connection device as claimed in claim 8, wherein the second portion comprises at least one second base delimiting at least one second shoulder relative to the cylinder.

10. The connection device as claimed in claim 9, wherein the second base is configured to come to bear against a terminal part of a drive arm.

11. The connection device as claimed in claim 10, wherein the second base comprises at least flat configured to come to bear against the terminal part of the drive arm.

12. The connection device as claimed in claim 1, wherein the adapter comprises a device configured to block movements in translation of the adapter on the drive arm.

13. The connection device as claimed in claim 12, wherein the device is a finger disposed on the upper wall of the adapter, the finger being configured to be inserted in a window arranged on a terminal part of a drive arm.

14. The connection device as claimed in claim 1, wherein the adapter comprises a change of section arranged at the intersection of a head and a body of the adapter, the head and the body extending in line with each other in a longitudinal direction of the adapter.

15. The connection device as claimed in claim 14, wherein the orifices of the adapter are situated in the body of the adapter.
